(19) United States
(12) Patent Application Publication
(10) Pub. No.: US 2010/0066640 A1
(43) Pub. Date: Mar. 18, 2010

(54) Electronic Device with Locking, Movable Displays

(75) Inventor: Ivan Nelson Wakefield, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/209,237

(22) Filed: Sep. 12, 2008

(51) Int. Cl. G09G 5/00

(52) U.S. Cl. 345/1.1

(57) ABSTRACT

An electronic device comprises one or more input devices configured to receive user input from a device user, a first display configured to display first visual content to the device user, and a second display configured to display second visual content to the device user and movable between first and second positions, wherein at least a portion of the second display is hidden from the user in one of the first and second positions and visible to the device user in the other. The device further comprises an electronically controlled retaining mechanism configured to retain the second display in the first position when engaged and a control circuit configured to execute an interactive user application, to control the display of the first and second visual content on the first and second displays, and to disengage the retaining mechanism in response to a pre-determined combination of user input and/or application state.

### TECHNICAL FIELD

The present invention relates generally to portable electronic devices, and particularly to electronic devices having multiple display devices.

### BACKGROUND

In recent years, portable electronic devices have become increasingly complex. While single-purpose devices, such as mobile phones, music players, and the like are still available, multi-functional portable devices are increasingly common. For instance, mobile telephones are now used to surf the web, send and receive e-mail messages, chat with friends, view images, play music, and games, and perform other tasks that previously required a computer. Many mobile telephones now also include a camera for capturing still and video images.

One of the challenges facing manufacturers of portable devices is how to increase the display area without significantly increasing the size of the device. A larger display area makes it easier to use the device and is generally preferred by consumers. At the same time, other features, such as full QWERTY keyboards, are competing with the display for position on the device, while consumers generally prefer devices that have a small form factor. However, not all of the functions of a multi-purpose require an extensive display area. Therefore, there is a need for new ways to provide increased display area in portable devices while maintaining small form factors and flexible usage models.

### SUMMARY

Embodiments of the present invention comprise an electronic device, such as a portable gaming device, mobile phone handset, or the like, including a primary display device and a second display device. The second display is movable between a closed position, wherein at least a portion of the second display is hidden from the user of the device, and an open position, wherein that portion is visible to the device user. In various embodiments, the second display may be selectively locked in the closed, position, under the control of an interactive software application running on the electronic device. In some embodiments, the second display is unlocked, and freely movable between the open and closed positions by the device user, responsive to a pre-determined combination of application state and user input. In other embodiments, the movement of the second display between the first and second positions may be powered by a drive mechanism, such as a motorized rack and pinion, under the control of the interactive software application, so that the application actively moves the second display between the closed and open positions in response to pre-determined triggering events.

The apparatus and methods disclosed herein may be particularly adapted to game software executing on a portable gaming device or on a multi-function device such as a mobile telephone. In such embodiments, access to the second display may be provided as a reward to the device, e.g., for completing a pre-determined game stage, and may serve to enlarge the total display and/or to expose an additional function or tool needed in the game, or to provide visual content that provides an alternative or enhanced view of the visual content provided on the primary display.

For example, at the start of a game the second display may be partially or totally hidden until a point in the game where certain obstacles have been overcome. At this point, the second display may be moved, or may automatically move, to provide the player with an extra tool, weapon, or power to use in subsequent stages of the game. Alternatively, a larger or more complete view of something in the game may become available to allow more possible actions for the game player. Of course, embodiments of the present invention are not limited to game applications or gaming devices.

Upon reading the detailed description below and viewing the accompanying drawings, those skilled in the art will appreciate that exemplary embodiments of the present invention include, but are not limited to:

(a) An electronic device comprising one or more input devices configured to receive user input from a device user, a first display configured to display first visual content to the device user, and a second display configured to selectively display second visual content to the device user and movable between first and second positions, wherein at least a portion of the second display is hidden from the user in one of the first and second positions and visible to the device user in the other. The electronic device further comprises an electronically controlled retaining mechanism configured to retain the second display in the first position when engaged, and a control circuit configured to execute an interactive user application, to control the display of the first and second visual content on the first and second displays, and to disengage the retaining mechanism in response to a first pre-determined application state.

(b) An electronic device as in (a), wherein the control circuit is configured to disengage the retaining mechanism in response to the first pre-determined application state and at least one pre-determined user input.

(c) An electronic device as in (a), wherein the at least one pre-determined user input comprises a pre-determined sequence of user inputs, a pre-determined combination of simultaneous user inputs, or both.

(d) An electronic device as in (a), wherein the portion of the second display is visible in the second position and wherein the control circuit is further configured to display the second visual content on the second display in response to the first pre-determined application state or, in some embodiments, in response to the first pre-determined application and at least one pre-determined user input.

(e) An electronic device as in (a), wherein the second display is configured to slide between the first and second positions, under manual control of the user, when the retaining mechanism is disengaged.

(f) An electronic device as in (e), wherein the control circuit comprises a detection circuit configured to detect movement of the second display to at least one of the first and second positions, and wherein the control circuit is further configured to vary the second visual content displayed on the second display based on the second display's position.

(g) An electronic device as in (a), wherein the electronically controlled retaining mechanism comprises a drive mechanism configured to move the second display between the first and second positions under the control of the control circuit, and wherein the control circuit is further configured to disengage the retaining mechanism in response to the first pre-determined application state or, in some embodiments, in response to the first pre-determined application and at least one pre-determined user input, by activating the drive mechanism to move the second display from the first position to the second position.

(h) An electronic device as in (g), wherein the control circuit is further configured to activate the drive mechanism to move the second display from the second position to the first position in response to a second pre-determined application state.

(i) An electronic device as in (a), further comprising a drive mechanism separate from said electronically controlled retaining mechanism and configured to move the second display between the first and second positions under the control of the control circuit, wherein the control circuit is further configured to activate the drive mechanism to move the second display from the first position to the second position in response to the first pre-determined application state or, in some embodiments, in response to the first pre-determined application and at least one pre-determined user input.

(j) An electronic device as in (i), wherein the control circuit is further configured to activate the drive mechanism to move the second display from the second position to the first position in response to a second pre-determined application state.

(k) An electronic device as in (a), wherein the electronically controlled retaining mechanism comprises one or more of a linear actuator, including a piston configured to retain the second display in the first position when engaged, a linear solenoid, including a shaft configured to retain the second display in the first position when engaged, and a magnetic latch.

(l) An electronic device as in (a), wherein the electronically controlled retaining mechanism comprises a rotating shaft coupled to a radially projecting element so that the radially projecting element retains the second display in the first position when the shaft is in a first orientation but allows the second display to move from the first position when the shaft is in a second orientation.

(m) A method of controlling a electronic device having first and second displays, the second display movable between first and second positions, wherein at least a portion of the second display is hidden from a device user in one of the first and second positions and visible to the device user in the other. The method comprises executing an interactive user application, controlling the display of first and second visual content on the first and second displays, respectively, responsive to input from the device user and the interactive user application, and selectively disengaging an electronically controlled retaining mechanism configured to retain the second display in the first position when engaged, in response to a first pre-determined application state.

(n) A method as in (m), wherein selectively disengaging the electronically controlled retaining mechanism comprises disengaging the retaining mechanism in response to the first pre-determined application state and at least one pre-determined user input.

(o) A method as in (m), wherein the portion of the second display is visible in the second position and wherein controlling the display of first and second visual content comprises displaying the second visual content on the second display in response to the first pre-determined application state or, in some embodiments, in response to the first pre-determined application and at least one pre-determined user input.

(p) A method as in (m), wherein the second display is configured to slide between the first and second positions, under manual control of the user, when the retaining mechanism is disengaged, the method further comprising selectively displaying the second visual content on the second display in response to movement of the second display to the position in which the portion of the second display is visible.

(q) A method as in (m), wherein the electronically controlled retaining mechanism comprises a drive mechanism configured to move the second display between the first and second positions and wherein selectively disengaging the electronically controlled retaining mechanism comprises activating the drive mechanism to move the second display from the first position to the second position.

(r) A method as in (q), further comprising activating the drive mechanism to move the second display from the second position to the first position in response to a second pre-determined application state.

(s) A method as in (m), wherein the electronic device further includes a drive mechanism separate from said retaining mechanism and configured to move the second display between the first and second positions, the method further comprising activating the drive mechanism to move the second display from the first position to the second position in response to the first pre-determined application state or, in some embodiments, in response to the first pre-determined application and at least one pre-determined user input.

(t) A method as in (s), further comprising activating the drive mechanism to move the second display from the second position to the first position in response to a second pre-determined application state.

Of course, those skilled in the art will appreciate that the present invention is not limited to the above features, advantages, contexts or examples, and will recognize additional features and advantages upon reading the following detailed description and upon viewing the accompanying drawings.

### BRIEF DESCRIPTION OF THE DRAWINGS

FIGS. 1A and 1C illustrate an exemplary electronic device having a second movable display in a closed position.

FIGS. 1B and 1D illustrate the exemplary electronic device of FIGS. 1A and 1C with the second movable display device in an open position.

FIG. 2 is a block diagram illustrating functional elements of an exemplary electronic device according to some embodiments of the present invention.

FIG. 3 illustrates an exemplary drive mechanism for moving a second display device between open and closed positions.

FIG. 4 illustrates an exemplary retaining mechanism, comprising a linear actuator.

FIG. 5 illustrates another exemplary retaining mechanism, comprising a magnetic latch.

FIG. 6 illustrates another exemplary retaining mechanism, comprising a rotating cam.

FIG. 7 is a process flow diagram illustrating an exemplary method for controlling a consumer device with a movable second display device.

FIG. 8 is another process flow diagram illustrating an exemplary method for controlling a consumer device having a drive mechanism for moving a second display device.

FIG. 9 is another process flow diagram illustrating an exemplary method for controlling a consumer device with a movable second display device according to some embodiments of the present invention.

### DETAILED DESCRIPTION

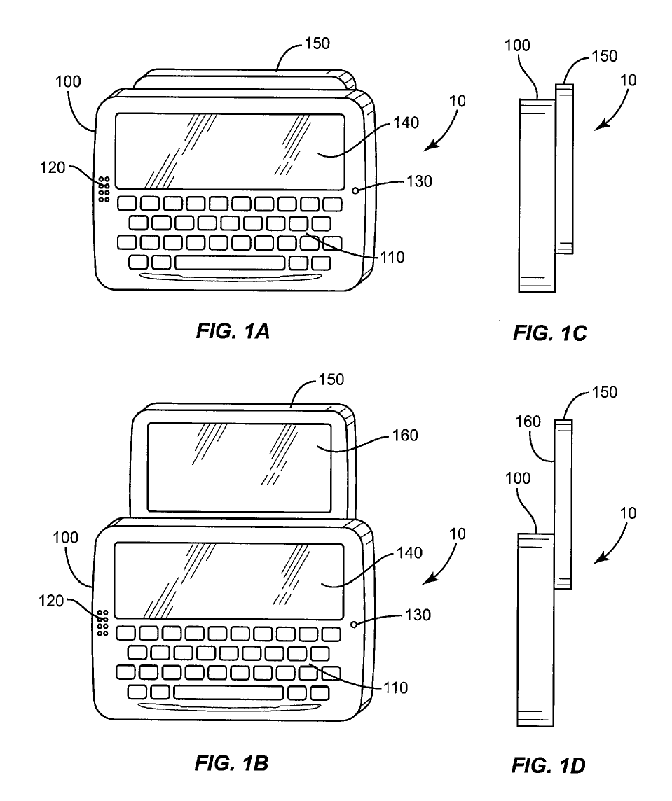

Referring now to the drawings, a portable electronic device 10 according to one exemplary embodiment of the present invention is shown in the several views of FIGS. 1A, 1B, 1C, and 1D. The illustrated embodiment of the mobile communication device comprises a smart phone or a wireless-enabled personal digital assistant (PDA), but those skilled in the art will appreciate that the portable electronic device 10 may also comprise a tablet computer, portable gaming device, portable music player, or the like, with or without wireless communications capabilities.

Portable electronic device 10 comprises a main housing 100, which contains several user input and output devices, including a keypad 110, speaker 120, microphone 130, and electronic display device 140. In some embodiments the electronic display 140 comprises a touch-screen interface, so that electronic display device 140 doubles as an input and output device, but electronic display device 140 may simply comprise a conventional liquid crystal display or other type of electronic display.

Portable electronic device 10 further comprises a second display housing 150, which contains a second electronic display device 160. In FIGS. 1A and 1C, the second display housing 150 is in a closed position, in which the display device 160 is hidden from the device's user. In FIGS. 1B and 1D, the second display housing 150 is in an open position, in which the display device 160 is visible to the device's user. In some embodiments electronic display device 160 may comprise a touch-screen interface.

In the embodiment pictured in FIGS. 1A-1D, the second display housing 150 is adjacent to and behind the main housing 100. In the closed position, the second display housing 150 may be mostly or completely behind the main housing 100. In the fully open position, all or substantially all of the second display 160 is visible to the user of the device. Of course, those skilled in the art will appreciate that the second display housing 150 may come to rest at one or more intermediate positions in some embodiments, such that only part of the second display 160 is visible to the device user. Further, those skilled in the art will appreciate that other embodiments of electronic device 10 may be configured so that the second display housing 150 is partially or completely enclosed by the main housing 100, when in the closed position, rather than substantially adjacent to the main housing 100.

Those skilled in the art will also appreciate that various techniques are possible for affixing the second display housing 150 to the main housing 100 so that the second display housing 150 may be moved between the open and closed positions. For example, simple sliding mechanisms, analogous to the slides used in cabinet drawers, may be used. Similarly, various well known techniques may be used for transferring electrical power and control signals from main housing 100 to second display housing 150. For instance, one or more flexible cable harnesses or flex circuits may be used. Because the details of various sliding mechanisms and electrical connection means are well known to those skilled in the art and are not important to an understanding of the present invention, these details are not illustrated in the attached figures, and are not discussed further herein.

Various embodiments of portable electronic device 10 include an electronically controlled retaining mechanism configured to retain the second display housing 150 in the closed position when the retaining mechanism is engaged. In some of these embodiments, as will be discussed in more detail below, the second display housing 150 may slide relatively freely once the retaining mechanism is disengaged, so that the device's user may move the second display housing 150 from the closed to the open position. In some embodiments, the retaining mechanism may comprise a drive mechanism that holds the second display housing 150 in the closed position until the drive mechanism is activated to move the second display housing 150 into the open position. Still other embodiments may include a drive mechanism that is separate from the electronically controlled retaining mechanism.

The mechanical configurations discussed above, and variations thereof, enable new usage models for multi-display devices. For example, in some embodiments of the present invention, the second display 160 may be made selectively available to the user by a game application. In these embodiments, the second display 160, which is normally hidden behind or inside the main housing 100, is exposed to the user only upon the satisfaction of a pre-determined game condition, such as the achievement of a certain game level and/or the entering of a certain key sequence or key combination. In response to this trigger condition, the second display housing 150 may be “unlocked,” in some embodiments, so that the user can move the display 160 into a visible position. In other embodiments, a drive mechanism may automatically move the display 160 into the visible position in response to the trigger condition.

The exposure of the second display 160 may in some cases serve simply be to enlarge the total display available display area, while in other embodiments the exposed second display 160 may reveal new information, or a new tool or function needed to advance in the game, or it may provide an enlarged or supplemental view of the content displayed on the first display 140, thus providing details of that content that would not otherwise be visible. Conversely, the game application may selectively hide the second display 160, in response to a particular application state and/or key sequence or combination, thus decreasing the display size and/or taking away a tool or view.

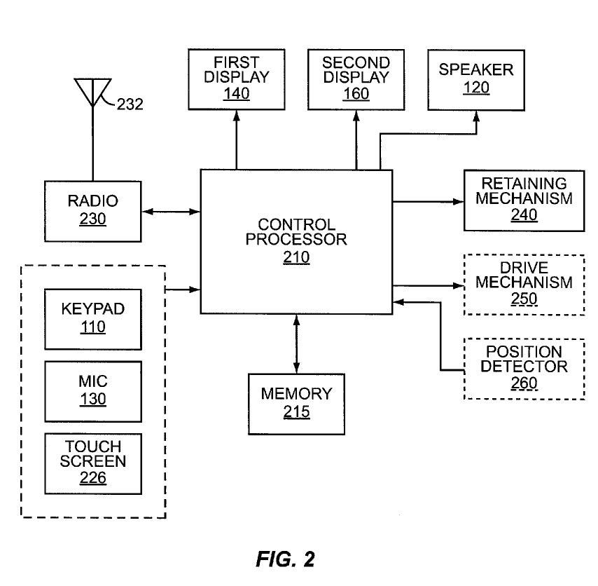

FIG. 2 is a block diagram illustrating functional elements of an electronic device 10 according to some embodiments of the present invention. Electronic device 10 thus includes a control processor 210, which may include one or more microprocessors, microcontrollers, digital signal processors (DSPs), or the like, coupled to memory 215 through an addressable data bus. Those skilled in the art will appreciate that memory 215 is representative of the one or more memory devices containing the software and data used by control processor 210 to operate the electronic device 10, and may also store one or more user applications, such as games, a music/video player, or the like, one or more of which may be installed by a user. Memory 215 may include one or several distinct units, and may include, but is not limited to, the following types of devices: cache, ROM, PROM, EPROM, EEPROM, flash, SRAM, DRAM, optical storage devices, and magnetic storage devices.

In the embodiment pictured in FIG. 2, electronic device 10 also includes several user input devices 220 coupled to control processor 210, including keypad 110, microphone 130, and touch-screen interface 226. Touch-screen interface 226 may correspond to the first display 140, second display 160, or both, in various embodiments. Output devices include the aforementioned first and second displays 140 and 160, as well as speaker 120. In some embodiments, electronic device 10 may support one or more communication interfaces, whether wireless or wired; thus the device pictured in FIG. 2 includes a radio transceiver unit 230, coupled to antenna 232. Radio transceiver unit 230 may be configured to provide wireless data and/or voice communications via one or more wireless standards, for example, such as the 802.11 family of wireless local-area network standards, or the 3GPP or 3GPP2 families of wide-area wireless communications standards.

Finally, electronic device 10 includes an electronically controlled retaining mechanism 240 as discussed above, configured to retain the second display 160 in one or more fixed positions when engaged. As particularly pictured in each of FIGS. 4-6, exemplary retaining mechanisms may be configured to retain the second display 160 in the closed position, so that second display 160 is not visible to the device user. However, those skilled in the art will appreciate that similar retaining mechanisms, or combinations thereof, may be configured to retain the second display in one or more of several positions, such as completely open, so that the entire display is visible, or partially open, so that only a portion of the second display is visible. Various non-limiting examples of possible retaining mechanisms will be illustrated in further detail below.

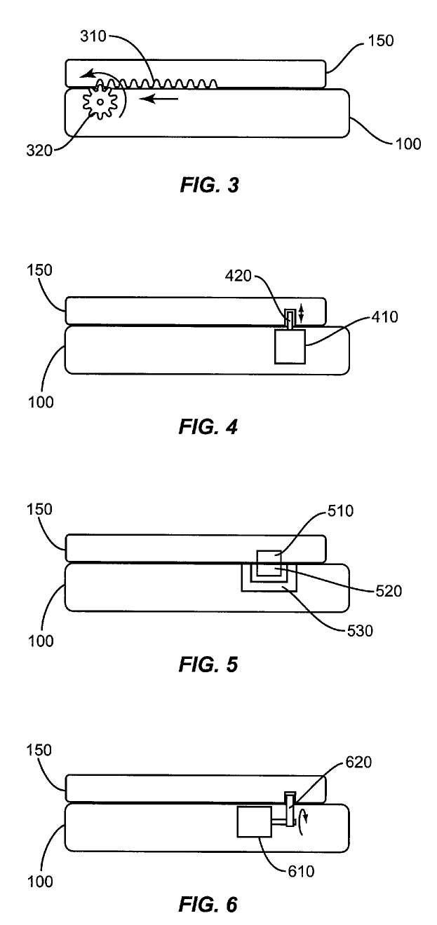

In some embodiments, electronic device 10 further includes a drive mechanism 250, for automatically moving the second display 160 between the open and closed positions. In other embodiments, electronic device 10 may include a position detector 260 configured to sense that the second display 160 has been moved by the device user to the open position. FIG. 3 illustrates one possible embodiment of a drive mechanism configured to move the second display housing 150 between the open and closed positions. Those skilled in the art will appreciate that the pictured drive mechanism is a rack and pinion apparatus, with the rack 310 affixed to the second display housing 150 and the rotating pinion 320 embedded in the main housing 100 and driven by a motor (not shown) under the control of control processor 210.

Those skilled in the art will further appreciate that various configurations for a rack and pinion apparatus are possible. For example, the positions of rack 310 and pinion 320 may be reversed, so that the motor and pinion 320 are located in the second display housing 150. However, the motor and pinion 320 will typically take up more space than the rack 310, and thus may often be advantageously located in the larger main housing 100. Further, those skilled in the art will appreciate that rack 310 may be formed as part of second display housing 150, instead of comprising a separate component attached to the second display housing 150.

If the motor driving the rack and pinion mechanism of FIG. 3 is equipped with a locking mechanism, so that the pinion 320 cannot be easily rotated by the device user when the motor is not activated, then the rack and pinion apparatus can serve as the retaining mechanism as well as a drive mechanism, as it will tend to retain the second display housing 160 in the closed position (or other at-rest position) when not actively moving the display housing 160. In other configurations, however, the motor driving the rack and pinion apparatus or other drive mechanism may be configured to freely rotate when not activated, in which case a separate retaining mechanism, including but not limited to any of the mechanisms pictured in FIGS. 4-6, may be used in addition to the drive mechanism.

FIG. 4 illustrates one such retaining mechanism, comprising a solenoid 410 configured to move a shaft 420 between a first position, in which the shaft 420 engages a notch, slot, or hole in the second display housing 150, and a second position, disengaged from the second display housing 150. Because solenoids typically apply force in only one direction, the solenoid 410 of FIG. 4 may be spring-loaded, to keep the shaft 410 in a “default” position when the solenoid 410 is not activated. Those skilled in the art will appreciate that this default position may be either of the engaged or disengaged positions, in various embodiments of the invention.

In other embodiments, the retaining mechanism may comprise an electro-mechanical linear actuator, including, but not limited to, linear actuators relying on a “jackscrew” mechanism to convert rotary motion into linear motion. In such embodiments, the linear actuator may be configured to move a piston in and out of a notch, slot, or hole in the second display housing 160, under the control of control processor 210. Because the general principle of the linear actuator-based retaining mechanism is similar to that of the solenoid, the former mechanism is not pictured separately. Indeed, those skilled in the art will appreciate that the solenoid 410 may be viewed as a type of linear actuator; the separate discussion of each herein is not intended to limit the generality of either term as generally understood in the art.

FIGS. 5 and 6 illustrate two additional retaining mechanisms that may be employed in some embodiments of the invention. FIG. 5 illustrates a magnetic latch, comprising two permanent magnets 510 and 520 that are configured with opposite poles immediately opposed to one other when the second display housing 150 is in the closed position. With this configuration, the second display housing 150 will tend to stay closed, and may require considerable force to open it. An electromagnet 530 is disposed within the main housing 100, around or adjacent to the permanent magnet 520. When energized, the magnetic field generated by electromagnet 530 fully or partially cancels the magnetic field generated by permanent magnet 520, thus releasing the magnetic latch. Those skilled in the art will appreciate that several alternative configurations for a magnetic retaining mechanism are possible, including a configuration with only a single permanent magnet (e.g., in the second display housing 150) and an electromagnet in the opposing housing. However, in this latter configuration, the electromagnet must be energized to keep the retaining mechanism engaged, whereas the electromagnet 530 in the illustrated configuration need only be energized in order to disengage the retaining mechanism. As is the case with all of the retaining mechanisms illustrated herein, the active portion of the magnetic latch may be located in the second display housing 150, rather than in the main housing 100, in some embodiments.

FIG. 6 illustrates yet another retaining mechanism, including a motor 610 configured to rotate a shaft with a radially projecting element 620 attached. The radially projecting element 620 may comprise a pin, tab, eccentric disc, or the like, and is configured so as to engage a notch, slot, or hole in the second display housing 150, in at least a first orientation. When the shaft is in at least one other orientation, the second display housing 150 is able to move, unimpeded by the projecting element 620. As with the previously described retaining mechanisms, the motor 610 and radially projecting element 620 may be affixed to the second display housing 150, rather than the main housing 100, if the available space permits.

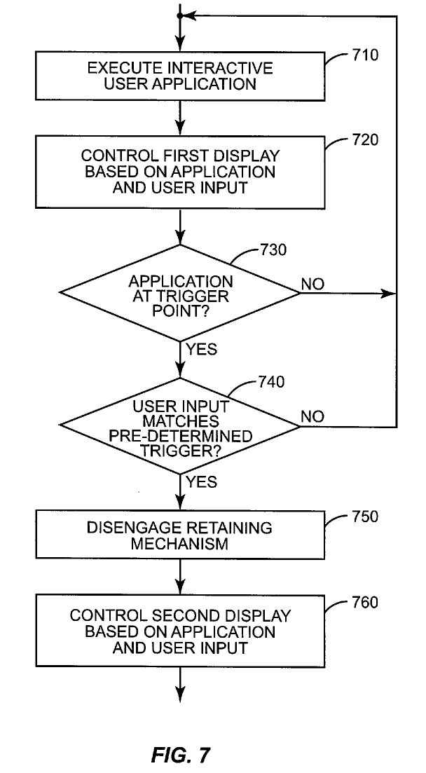

With the above-described mechanical configurations in mind, those skilled in the art will readily understand the general method presented in FIG. 7 for controlling an electronic device having first and second displays, wherein the second display is movable between first and second positions, in which at least a portion of the second display is hidden from a device user in one of the first and second positions and visible to the user in the other.

The following discussion of the process illustrated in FIG. 7 generally assumes that the second display is initially in the closed position (i.e., not visible to the user). However, those skilled in the art will appreciate that the illustrated process may be adapted for mechanisms configured to “lock” the second display at other positions as well. In any case, the pictured process “begins” at block 710, with the execution of an interactive user application. This user application may comprise, for example, a game or other software application designed for entertainment purposes, but might also comprise any other application suitable for execution on the device, including so-called “productivity” applications, such as word processors, e-mail clients, or spreadsheet applications. Depending on the configuration of the electronic device, the interactive user application may comprise a user-installed software application, loaded into RAM and executed by a device-specific operating system, or may comprise an embedded device-specific application pre-installed on the device at the time of manufacture.

In any case, the interactive user application is generally responsive to user input supplied via one or more user input devices, such as the keypad 110, microphone 130, or touch-screen interface 226 of FIG. 2. In some embodiments, the device may include additional user input devices including, but not limited to, a still and/or video camera, motion/gesture detectors, or the like. Some interactive user applications may be responsive to input from one or more of these devices. In any event, in response to user input, the interactive user application generally causes the display of first visual content, as shown at block 720, on the primary display 140. This first visual content may include text, graphics, or a combination thereof.

The interactive user application may comprise one or several “trigger points,” or pre-determined states. These trigger points may comprise, for example, a particular stage in a game application, or the activation of a particular application menu or function. If one of these trigger points has not yet been reached, execution of the interactive user application and control of the first display continues normally, as shown at blocks 710-730. If the application is at a trigger point, on the other hand, then certain user input may cause the retaining mechanism for the second display to be disengaged, as shown at blocks 740 and 750. The interactive user application then causes second visual content to be displayed on the second display, which is now available to be viewed by the user.

Broadly speaking, a triggering event may comprise any pre-determined application state or combination of pre-determined application state and at least one pre-determined user input. In some embodiments, a particular sequence of user inputs, a particular combination of simultaneous user inputs, or both, may be necessary to complete the trigger event. If the trigger event is not detected, the execution of the interactive user application and the control of the first display continues. If the trigger event is detected, on the other hand, then the retaining mechanism is disengaged, and the second display is made available for use.

In some embodiments, as noted above, the retaining mechanism may comprise a drive mechanism configured to move the second display between the closed and open positions, so that disengaging the retaining mechanism comprises activating the drive mechanism to move the second display from one position to another. In other embodiments, the electronic device may comprise a drive mechanism in addition to another retaining mechanism, including, but not limited to, any of the alternative mechanisms described above.

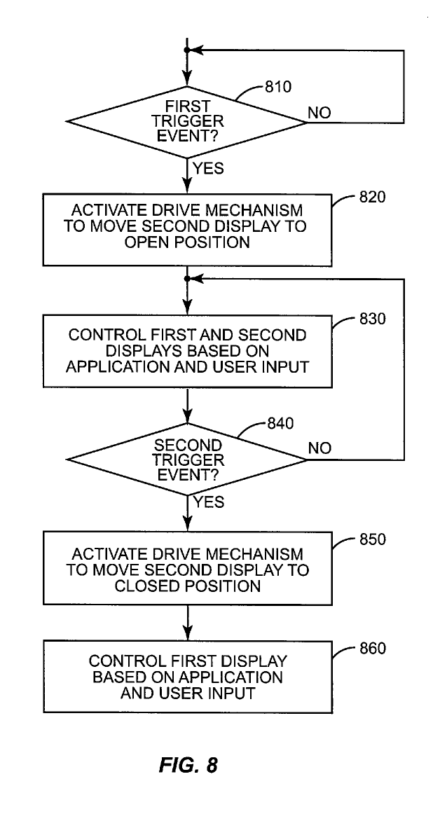

FIG. 8 illustrates a method for controlling a secondary display in such embodiments. As with FIG. 7, the process flow of FIG. 8 assumes that the second display is initially in a closed position; those skilled in the art will readily understand how to modify the various process flows discussed herein to accommodate a scenario in which all or a portion of the second display is initially visible.

At block 810, an interactive user application monitors the application state and/or user input for a first trigger event, which may correspond to one or more pre-determined application states, or one or more combinations of user input and application state. If the trigger event is detected, the drive mechanism is activated to move the second display from the closed position to the open position, as shown at block 820. If the drive mechanism and the retaining mechanism are one and the same, then this action also comprises the disengagement of the retaining mechanism, such as is illustrated at block 750 of FIG. 7. On the other hand, if the retaining mechanism is distinct from the drive mechanism, then the retaining mechanism must be disengaged before the drive mechanism is activated; this separate operation is not illustrated in the exemplary embodiment of FIG. 8.

Block 830 illustrates the control of both the first and second displays, based on the interactive user application state(s) and user input. As noted above, the second display may be used to augment the limited display area of the first display, to provide additional features or tools for use with the interactive user application, or to provide alternative views to the visual content provided on the first display. In some embodiments, the second display may be configured with a touch-screen interface, so that the availability of the second display provides an additional user input device.

At block 840, the control processor of the electronic device monitors the application state and/or user input for a second trigger event, which may comprise any one of a second set of pre-determined application states and/or combinations of application state and user input. If a second trigger event is detected, then the drive mechanism is activated to move the second display to the closed position, as shown at block 850, and control of the first display continues, as shown at block 860. In some embodiments, the second display may be partially or completely shut down, when in the closed position, to save power.

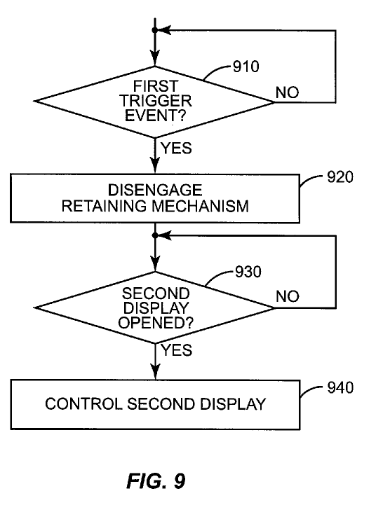

In some embodiments of the present invention, as noted above, the electronic device may lack a drive mechanism. In these embodiments, the second display may be configured to slide between the closed and open positions, under manual control of the user, when the retaining mechanism is disengaged. In some of these embodiments, the device includes a position detector configured to detect that the second display has been moved to one or more fixed positions, such as the fully closed or open positions. The display of supplemental visual content to the second display may thus be varied, based on the second display's position. For example, in response to sliding the second display to a full or partially open position, the second display may be activated and supplemental visual content provided to the second display. If the display is only partially open, the size or content of the supplemental visual content may be varied accordingly, in some embodiments. An exemplary process corresponding to one or more of these embodiments is provided in FIG. 9.

At block 910, a first trigger event is detected. As in the previously discussed methods, the detection of this trigger event causes the disengagement of the retaining mechanism, as shown at block 920. However, in this embodiment the second display is not automatically opened. Thus, activation of the second display and/or the display of second visual content on the second display may be deferred until the display is actually moved, by the user, to the open position. When the control processor detects that the second display has been opened, as shown at block 930, then the second display is placed under active control, as shown at block 940.

Various mechanical configurations of an electronic device have been disclosed herein, as have several methods for controlling the displays of such a device. Those skilled in the art will appreciate that each of the various device configurations described herein, as well as variations thereof, may be configured to carry out one or more of the methods illustrated herein, and suitable variations thereof. Thus, an exemplary electronic device 10 may comprise a control circuit configured with appropriate hardware, software, firmware, or some combination thereof, to implement any of the methods illustrated and described herein. In a similar manner, those skilled in the art will appreciate that any of the particular methods described herein may be adapted to the particulars of any of the device configurations discussed herein. The present invention may, of course, be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. An electronic device comprising:
one or more input devices configured to receive user input from a device user;
a first display configured to display first visual content to the device user;
a second display configured to selectively display second visual content to the device user and movable between first and second positions, wherein at least a portion of the second display is hidden from the user in one of the first and second positions and is visible to the device user in the other;
an electronically controlled retaining mechanism configured to retain the second display in the first position when engaged; and
a control circuit configured to execute an interactive user application, to control the display of the first and second visual content on the first and second displays, and to disengage the retaining mechanism in response to a first pre-determined application state.

2. The electronic device of claim 1, wherein the control circuit is configured to disengage the retaining mechanism in response to the first pre-determined application state and at least one pre-determined user input.

3. The electronic device of claim 2, wherein the at least one pre-determined user input comprises a pre-determined sequence of user inputs, a pre-determined combination of simultaneous user inputs, or both.

4. The electronic device of claim 1, wherein the portion of the second display is visible in the second position and wherein the control circuit is further configured to display the second visual content on the second display in response to the first pre-determined application state.

5. The electronic device of claim 1, wherein the second display is configured to slide between the first and second positions, under manual control of the user, when the retaining mechanism is disengaged.

6. The electronic device of claim 5, wherein the control circuit comprises a detection circuit configured to detect movement of the second display to at least one of the first and second positions, and wherein the control circuit is further configured to vary the second visual content displayed on the second display based on the second display's position.

7. The electronic device of claim 1, wherein the electronically controlled retaining mechanism comprises a drive mechanism configured to move the second display between the first and second positions under the control of the control circuit, and wherein the control circuit is further configured to disengage the retaining mechanism in response to the first pre-determined application state by activating the drive mechanism to move the second display from the first position to the second position.

8. The electronic device of claim 7, wherein the control circuit is further configured to activate the drive mechanism to move the second display from the second position to the first position in response to a second pre-determined application state.

9. The electronic device of claim 1, further comprising a drive mechanism separate from said electronically controlled retaining mechanism and configured to move the second display between the first and second positions under the control of the control circuit, wherein the control circuit is further configured to activate the drive mechanism to move the second display from the first position to the second position in response to the first pre-determined application state.

10. The electronic device of claim 9, wherein the control circuit is further configured to activate the drive mechanism to move the second display from the second position to the first position in response to a second pre-determined application state.

11. The electronic device of claim 1, wherein the electronically controlled retaining mechanism comprises one or more of:
a linear actuator, including a piston configured to retain the second display in the first position when engaged;
a linear solenoid, including a shaft configured to retain the second display in the first position when engaged; and
a magnetic latch.

12. The electronic device of claim 1, wherein the electronically controlled retaining mechanism comprises a rotating shaft coupled to a radially projecting element so that the radially projecting element retains the second display in the first position when the shaft is in a first orientation but allows the second display to move from the first position when the shaft is in a second orientation.

13. A method of controlling a electronic device having first and second displays, the second display movable between first and second positions, wherein at least a portion of the second display is hidden from a device user in one of the first and second positions and visible to the device user in the other, the method comprising:
executing an interactive user application;
controlling the display of first and second visual content on the first and second displays, respectively, responsive to input from the device user and the interactive user application; and
selectively disengaging an electronically controlled retaining mechanism configured to retain the second display in the first position when engaged, in response to a first pre-determined application state.

14. The method of claim 13, wherein selectively disengaging the electronically controlled retaining mechanism comprises disengaging the retaining mechanism in response to the first pre-determined application state and at least one pre-determined user input.

15. The method of claim 13, wherein the portion of the second display is visible in the second position and wherein controlling the display of first and second visual content comprises displaying the second visual content on the second display in response to the first pre-determined application state.

16. The method of claim 13, wherein the second display is configured to slide between the first and second positions, under manual control of the user, when the retaining mechanism is disengaged, the method further comprising selectively displaying the second visual content on the second display in response to movement of the second display to the position in which the portion of the second display is visible.

17. The method of claim 13, wherein the electronically controlled retaining mechanism comprises a drive mechanism configured to move the second display between the first and second positions, and wherein selectively disengaging the electronically controlled retaining mechanism comprises activating the drive mechanism to move the second display from the first position to the second position.

18. The method of claim 17, further comprising activating the drive mechanism to move the second display from the second position to the first position in response to a second pre-determined application state.

19. The method of claim 13, wherein the electronic device further includes a drive mechanism separate from said retaining mechanism and configured to move the second display between the first and second positions, the method further comprising activating the drive mechanism to move the second display from the first position to the second position in response to the first pre-determined application state.

20. The method of claim 19, further comprising activating the drive mechanism to move the second display from the second position to the first position in response to a second pre-determined application state.
